(19) United States
(12) Patent Application Publication
(10) Pub. No.: US 2011/0240076 A1
(43) Pub. Date: Oct. 6, 2011

(54) WALKING AID

(76) Inventor: Brian Peter Hateley, Wigan (GB)

(21) Appl. No.: 13/075,586

(22) Filed: Mar. 30, 2011

(30) Foreign Application Priority Data
Apr. 1, 2010 (GB) 1005590.3

(51) Int. Cl. A45B 3/00; A61H 3/02

(52) U.S. Cl. 135/66

(57) ABSTRACT

A walking aid 9 comprising a body 4 which is attachable to a crutch is disclosed. The walking aid 9 provides a support aid to a user with an injured leg to allow said user to move around more easily. The walking aid 9 allows movement whilst maintaining stability of both itself and the user. The aid 9 is sufficiently strong enough to support the bodyweight of a user and the walking aid 9 allows a near-normal walking movement as only one crutch 2 is required to effect movement. The aid 9 is also adjustable such that it may be used by a variety of users of different heights and weights

### CROSS-REFERENCE TO RELATED APPLICATIONS

This application is related to and claims priority from earlier filed GB Patent Application No. 1005590.3 filed Apr. 1, 2010.

### BACKGROUND OF THE INVENTION

The present invention relates to a walking aid.

Crutches and other similar support devices such as walking sticks, staffs and canes are commonly recommended by the medical profession to facilitate mobility for patients who have sustained injury that compromises their ability to bear weight on an affected limb.

Known crutches typically comprise a tubular support structure with a rubber-foot which provides a slip resistant surface when in contact with the ground, and at the opposite end of the crutch assembly comprises a projecting hand support, typically projecting substantially perpendicular to the support structure which allows the patient to hold the crutch and use it to maintain balance and support bodyweight. The walking aid may also comprise an additional support above the hand support structure to support the patient's lower arm and to assist with stability during use of the aid.

A problem associated with the use of crutches is the risk of secondary injury as a result of the injured limb having to remain non-weight bearing, or at least only partially weight bearing. This inability to distribute a patient's bodyweight evenly between both legs means the uninjured leg must compensate for the deficit, meaning that there is an increased load placed on the limb which may result in injury to this leg, such as muscle strain.

There is also a significant risk of secondary injury arising from a potential loss of balance whilst using the crutches. In addition to the risk of injury, this loss of balance may not only cause the patient anxiety but also can compromise the level of general activity the patient is able to engage in during convalescence, which if severely impaired or particularly long in time, may promote further complications. An example of such a complication is, in extreme conditions, muscular atrophy.

A further problem with the use of conventional crutches is the risk of developing pressure lesions on the hands as a result of having to support the entire bodyweight through the hands whilst holding onto the crutches during movement.

Still further there can be problems associated with conventional crutches and that is that the patient may be unable to carry items safely in addition to the apparatus. This will necessarily restrict the patient's normal daily routine during convalescence and often means they are highly dependent on others for assistance.

Further also, many patients using crutches often experience fatigue as a result of both having to stand on one leg for significant periods of time and having to expend additional effort by having to use crutches to effect mobility.

It is accordingly an object of the present invention to provide a walking aid that overcomes or at least minimises the aforementioned problems associated with conventional crutches.

### BRIEF SUMMARY OF THE INVENTION

Thus and in accordance with the present invention there is provided: A walking aid comprising a body which is attachable to a crutch, said body being formed in such a manner so as to maintain stability of the assembly whilst in use and being capable of supporting substantially the full body weight of a user with an injured limb.

With this arrangement it will be appreciated that the problems hereinbefore identified in connection with known arrangements can be overcome completely or at least minimized by use of the assembly of the present invention.

Preferably a telescopic crutch is attached either to the interior or outside of the body as shown in FIGS. 5 and 6. In both cases (inside and outside), there is an attachment body, having a number of fasteners which can be used to retain the telescopic crutch.

One embodiment of a walking aid in accordance to the present invention may comprise an ergonomically designed lightweight body capable of being attached to a rigid support structure.

The arrangement of the present invention shall be such that the body can be of any suitable shape or size as desirable or as appropriate. The body can be formed of any suitable material such as foamed plastics or any other flexible or rigid plastics.

The body can be formed as a hollow body closed off by a lid: The lid comprising a cushioned top surface. Alternatively the body can be formed as a solid body of lightweight material and, in this case, one end of the body may support a cushioned surface.

In all embodiments the body shall be sufficiently strong and should be capable of supporting the entire body weight of a user.

Furthermore the arrangement of the present invention shall be capable of withstanding the weight of at least one human user.

The body may be fixedly or removably attached to the crutch in any suitable manner. The body shown in the Figures is attached to the crutch by way of an attachment body which secures the crutch and body together using fastener(s) of a suitable form. The fastener(s) are capable of being easily unfastened to allow the body to be separated from the crutch. The fasteners are formed from a sufficiently strong material for example metal, wood or suitably formed plastics material fit for the purpose.

It is to be preferred that the body is connected releasably to the crutch and is most preferably attached using a quick release mechanism of any suitable form.

If the body is of a hollow construction, then an internal space is available for storage of items if needed. The top of the body, in these circumstances, can be formed as a removable, sliding or hinged lid by way of which the internal space may be accessed. The internal space may also be accessed by drawers or doors or opening(s) in any one of the upright outer surfaces of the invention.

If the body is formed in one piece as a solid mass of material, then it may contain recesses or cavities in one or more of the surfaces for the storage and transportation of items.

In all of the embodiments the body of the walking aid will have attached to its underside a sole, comprising a slip resistant material such as rubber, the large surface area of which will greatly improve grip for crutch users.

The lid is preferably attached to the top of the body to prevent its loss. In both cases in which either the body is a one-piece structure or a hollow structure, a top surface of the walking aid is cushioned or otherwise made flexible to give a comfortable surface upon which a part of the user's lower leg, particularly the user's knee, can be supported in use as will be defined more completely hereinafter.

In one embodiment, the assembly is provided with an integral handle or crutch which may be formed so as to be telescopic, enabling ease of use and/or transportation and stowage, such as when the user is travelling on a train or airplane or motor vehicle.

At least one embodiment may have attached thereto on one of the outer surfaces of the body, a receptacle for the carriage of items such as a drinks holder whilst the other embodiments may have internal storage capacity and/or an external storage facility.

An arrangement may comprise a means to temporarily retain an additional crutch should the need arise.

### BRIEF DESCRIPTION OF THE DRAWINGS

The invention will now be described further by way of example only and with reference to the accompanying drawings in which;

FIG. 1 shows a schematic representation of one embodiment of walking aid assembly 9 in accordance with the present invention being used by a user with an injured right leg;

FIG. 2 shows a schematic representation of a side view of the body 4 of the walking aid 9 of FIG. 1;

FIGS. 3 and 4 show respectively schematic representation of a rear and front view the assembly of FIG. 2; and

FIGS. 5 and 6 show schematic representations of the body 4 of a walking aid 9 of FIG. 1, showing one or more fasteners 5 for attaching the body 4 to a crutch 2.

### DETAILED DESCRIPTION OF THE INVENTION

In use when a person fractures a lower limb it is usual for the bone to be set in a position in which it will heal. The part of the limb affected is usually placed in a plaster cast to allow it to heal. Furthermore, in such circumstances, it is usual for a pair of conventional crutches to be issued to the injured person to enable them to move around despite their injuries. However, any person who has had such an injury that requires the use of conventional crutches will confirm that it is not easy to walk using crutches of standard form for any great distance. It can also be difficult to get used to walking with crutches such that, by the time the injured person is used to and able to get around on these, it may be that the injury has almost healed therefore the crutches are also no longer required as the injured person can walk and continue their rehabilitation from the injury.

The arrangement of the present application shows the walking aid assembly 9 which can be height adjusted, such adjustment may be possible utilising spacers. For example, said spacers may be plates of an incompressible material placed between the lid 1 and the body 4 which may be releasably attached thereto using a number of fastenings such as hook and pile as produced under the registered trademark VELCRO, so as to allow users of different heights to use the walking aid assembly 9.

Movement using the walking aid assembly takes place as follows:

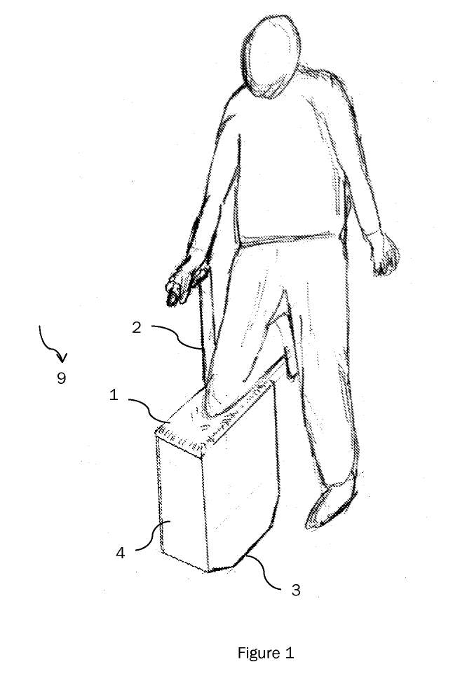

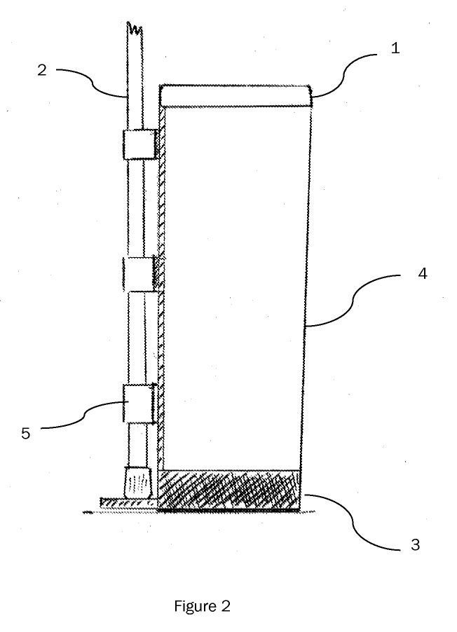

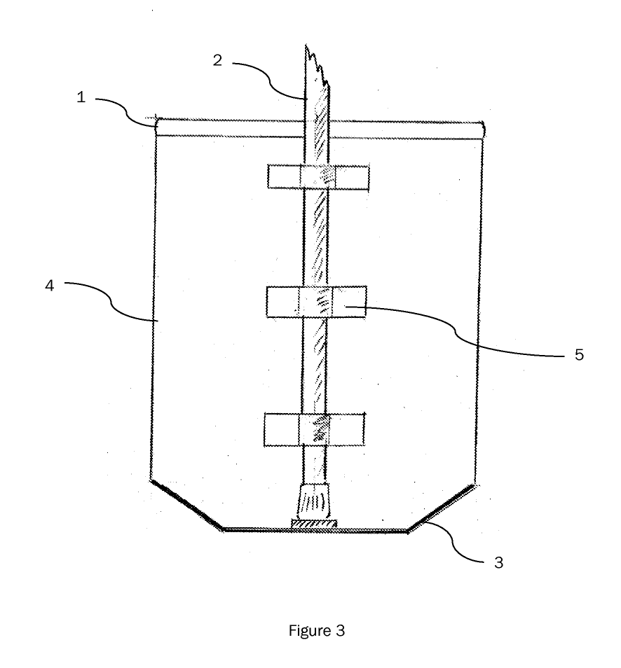

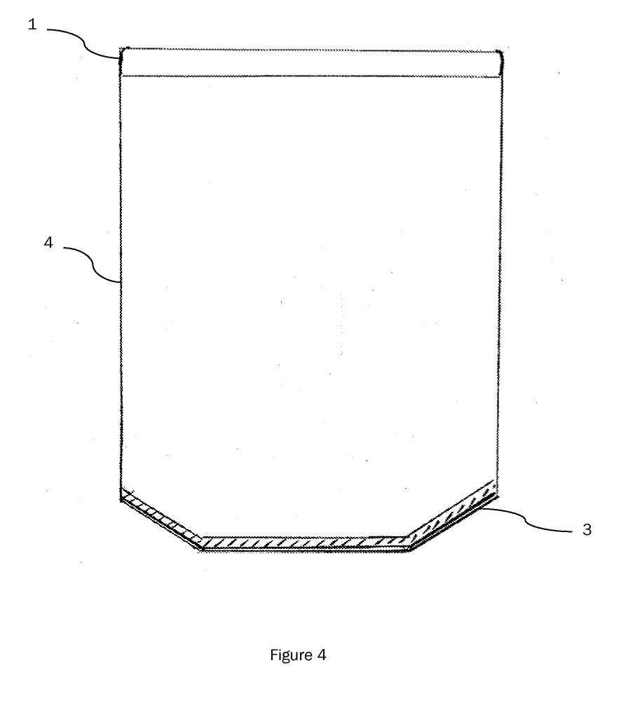

The user holds on to the crutch 2 as shown in FIG. 1 and would typically place the knee of their injured leg on top of the cushioned lid 1 of the walking aid assembly 9 and, as shown in the Figures, they are able to move simply by using a single crutch 2. Thus movement is instigated by the user holding on to the crutch 2 with their hand and lifting the walking aid assembly 9 simultaneously with the raising of the knee of the injured leg, such that ground contact is lost, then moving the limb and walking aid assembly 9 forward as one to make contact with the ground at a point further forward such that a normal stepping forward movement is established. Once ground contact is established the user's weight which up to this point has been borne by the non injured limb, is transferred to the knee making contact with the cushioned top surface 1 enabling the uninjured limb to move forward in a fashion which resembles normal walking movement, due to the fact that only a single crutch is necessary.

Thus, with the arrangement of the present invention, it is possible to provide a more easily used walking aid 9, which allows easy and comfortable movement, without the need for a second crutch on the other side of the user. Such a simple construction can be considerably more cost effective and advantageous to the user than the currently available crutches, crutch assemblies and walking aids.

Further the arrangement of the present invention provides greater stability and versatility than conventional crutches and further is much more comfortable. Thus, a user can be more flexible in terms of moving around than with conventional crutches. The present invention allows the user the ability to attend to such acts as bathing, cooking, household chores etc more easily effectively and safely. It also allows the user to stand upright for long periods with excellent balance properties.

The invention may be decorated or otherwise personalised by way of decals, or other methods of improving the aesthetic qualities and novelty value.

The word “crutch” in the above text is meant to be any implement of which the following are examples: crutch, stick, cane, pole, staff, crook, handle,

It will of course be understood that the invention is not intended to be restricted to the details of the embodiment described, above which is described by way of example only.

Thus for example the walking aid 9 can be utilised by persons having conditions of which the following are examples of the type which impose some restriction on their mobility:

sprained ankle; corns; bunions; inflamed tendons; muscle spasm; wounds; varicose veins.

Furthermore it can be arranged that the slip resistant sole 3 engages the ground in such a manner so as to cause the body 4 to lean towards the user to more closely resemble a normal posture when using the walking aid assembly 9.

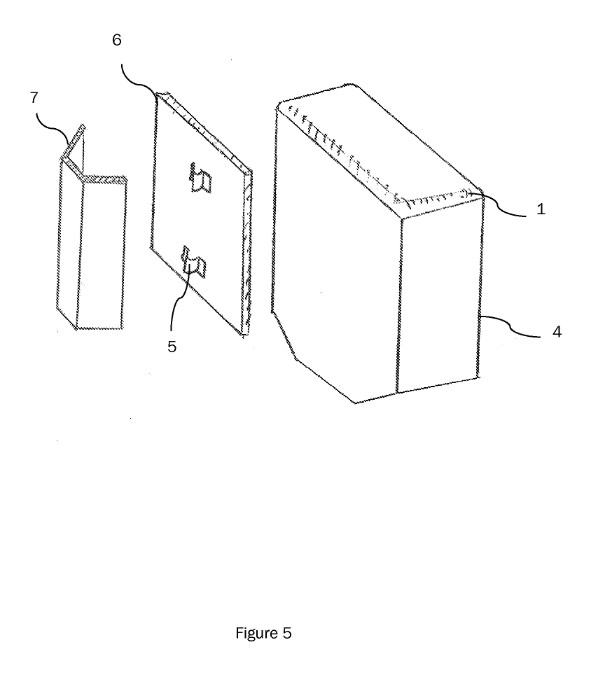

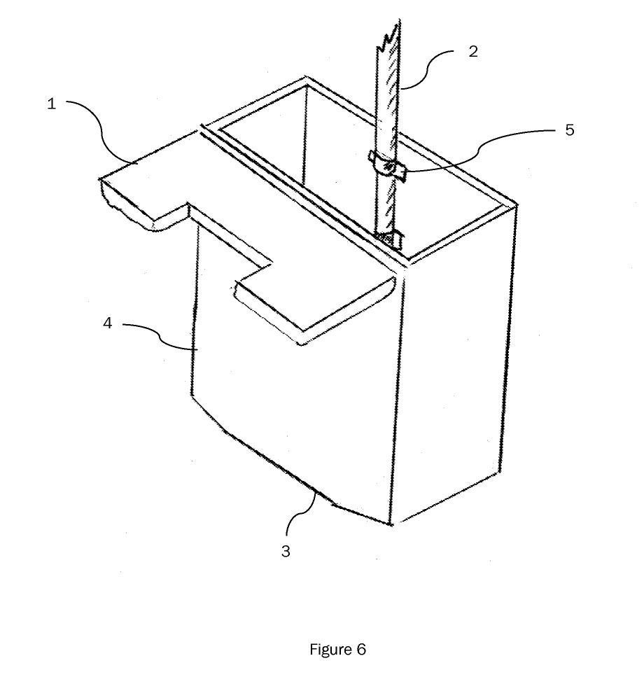

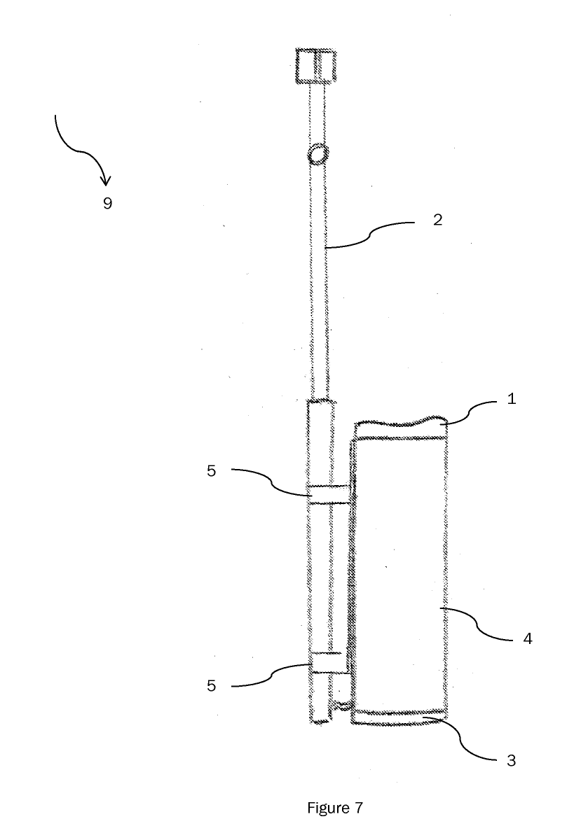

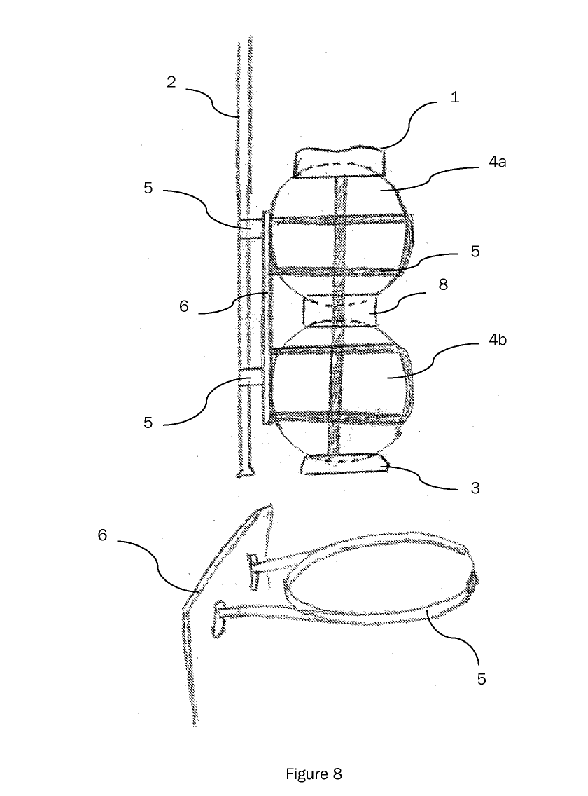

The device may have a fastener guard (cover) 7, such as that illustrated in FIG. 5, to protect or otherwise obscure from view the fasteners 5 for practical or decorative purpose. Such guard 7 is preferably to be semi-fixedly or releasable attached.

Said fastener guard 7 may be fastened by way of for example, a hinged or hook and pile arrangement.

Said fastener guard 7 may be suitably constructed so as to complement the shape/configuration of the underlying fasteners 5.

The walking aid 9 may be further arranged by comprising an inflatable body 4. It will be appreciated that such an embodiment not only reduces the weight of the walking aid 9 but also reduces the amount of storage space required when said walking aid 9 is not in use.

Furthermore, an embodiment of the inflatable type as described may also comprise a plurality of components which may or may not be inflatable. FIG. 7 illustrates a schematic representation of one embodiment of the walking aid assembly 9 incorporating an inflatable body 4 and FIG. 8 illustrates a schematic representation of one embodiment of the walking aid assembly 9 incorporating individual inflatable components 4a, 4b, such as for example, footballs.

In the embodiment shown in FIG. 7 the body structure comprises an ergonomically designed inflatable body 4, capable of being attached to a rigid support structure 2. The inflatable design facilitates ease of storage and transportation as well as being a less expensive alternative to some of the other embodiments.

In addition, the inflatable body 4 makes the overall walking aid 9 extremely lightweight which increases its appeal to some users.

The inflatable body 4 may comprise any suitable material capable of sustaining the weight of at least one user when said body 4 is inflated. The body section 4 may comprise one or more inflatable sub-sections (not illustrated), said inflatable sub-sections may be capable of simultaneous or independent inflation.

Said body section 4 is preferably capable of connecting to a pump mechanism (not illustrated) via a valve or other suitable connection, to facilitate inflation of the body structure 4. Said pump mechanism may be an integral part of the crutch or alternatively be an independent pump.

The inflatable body section 4 is preferably capable of attaching to the attachment body 6 of the walking aid 9 in any suitable manner, as in alternative embodiments.

The crutch 2 is preferably telescopic to facilitate easier storage and transportation and may be capable of incorporating a pneumatic pump mechanism (not illustrated) which may be used to inflate the body structure 4 as required. In such instances, the crutch and pump mechanism preferably incorporates a non-return valve or other such device to prevent unwanted deflation of the body structure 4. The crutch and pump mechanism preferably incorporates a valve to facilitate voluntary deflation of the body structure 4 as required.

The crutch and pump mechanism may also incorporate a pressure gauge (not illustrated) to enable the user to inflate the body structure 4 to a desired pressure.

In the embodiment shown in FIG. 8, the walking aid 9 comprises a body 4 which is attachable to a crutch 2, said body 4 comprising two or more independent components 4a and 4b. The independent components 4a and 4b may be either inflatable or rigid.

The independent components 4a and 4b are preferably separated by a bi-concave spacer device 8 that locates the individual components 4a and 4b one on top of the other to form the body structure 4. The spacer device 8 may be available in a range of sizes to accommodate varying sizes of individual components as well as being a means of adjusting the height of the body structure 4.

The body structure 4 may incorporate a knee seat 1 in order to support the user's knee and lower leg as in other embodiments. Preferably, one aspect of the knee seat 1 comprises complementary surface to accommodate the uppermost individual component, such as for example a concave surface to accommodate a spherical component.

The sole 3 of the walking aid 9 also preferably comprises a complementary surface to accommodate the lower individual component, in order that the sole 3 be connected to the body structure 4.

The individual components 4a and 4b of the body structure 4 are preferably secured to the crutch 2 by means of the attachment body 6 and adjustable fasteners 5, such as for example, flexible strapping as shown in FIG. 8. The body structure 4 comprising individual components 4a and 4b may also be covered by an external, removable cover (not shown).

One example of the present embodiment as shown in FIG. 8 incorporates footballs as the individual inflatable components 4a and 4b, which not only serve to form the body structure 4 of the walking aid 9, but also demonstrates the potential for the walking aid 9 to function as a storage device for the footballs, as these may be removed from the walking aid 9 for use if required, before being reattached in order that the walking aid 9 be used as a support device again.

What is claimed:

1. A walking aid comprising a body which is attachable to a crutch, said body being formed in such a manner as to maintain stability of the assembly whilst in use and being capable of supporting substantially the full body weight of a user with an injured limb.

2. A walking aid according to claim 1 in which a telescopic crutch is attached either to the interior or outside of the body.

3. A walking aid according to claim 2 wherein there is an attachment body having a number of fasteners to retain the telescopic crutch.

4. A walking aid according to any one of claim 1, said aid comprising an ergonomically designed lightweight body for attachment to a rigid support structure.

5. A walking aid according to any one of claim 1 wherein the body is formed from a plastics material.

6. A walking aid according to claim 5 wherein the body is formed from a plastics material chosen from a foamed plastics or flexible or rigid plastics materials.

7. A walking aid according to any one of claim 1 wherein the body is formed as a hollow body closed off by a lid, said lid comprising a cushioned top surface.

8. A walking aid according to any one of claim 1 wherein the body is removably attached to the crutch by way of an attachment body which secures the crutch and body together.

9. A walking aid according to any one of claim 1 in which said body is connected to the crutch using a quick release mechanism.

10. A walking aid according to any one of claim 1 wherein the aid further comprises a sole attached to its underside, said sole comprising a slip resistant material such as rubber.

11. A walking aid according to any one of claim 1 wherein said aid has attached thereto on one of the outer surfaces of the body a receptacle to allow items to be carried such as drinks.

12. A walking aid according to any one of claim 1 comprising a temporary retention means to retain an additional crutch.
